(19) United States
(12) Patent Application Publication
(10) Pub. No.: US 2006/0186255 A1
(43) Pub. Date: Aug. 24, 2006

(54) Cord storage reel with built-in plug and receptacle panel

(76) Inventor: Jeffrey F. Rooker, Arlington, TX (US)

Correspondence Address: Stephen S. Mosher;Whitaker, Chalk, Swindle & Sawyer, LLP, 3500 City Center Tower II, 301 Commerce Street, Fort Worth, TX, 76102-4186, US

(21) Appl. No.: 11/062,406

(22) Filed: Feb. 22, 2005

(51) Int. Cl. B65H 75/44; H02G 11/02

(52) U.S. Cl. 242/395; 242/396.1; 191/12.2 R

(57) ABSTRACT

A storage reel for an electrical cord includes a spool and an electrical circuit enclosed therein. The electrical circuit, contained within the hub of the spool, includes a standard AC plug mounted in a recessed cavity in the hub and wired to the line, neutral, and ground terminals of a plurality of standard AC receptacles mounted in an end of the hub on the side of the spool. A circuit breaker is included in the electrical circuit. The receptacle end of an extension cord is connected to the AC plug. The extension cord may then be coiled up around the hub of the spool for storage or transport.

### BACKGROUND OF THE INVENTION

1. Field of the Invention

The present invention generally relates to storage reels for storing long cords or hoses and, more particularly, to a storage reel for an electrical extension cord that includes an AC plug, for connecting an extension cord from a source of electric power, and a multiple AC receptacle outlet tap.

2. Description of the Prior Art

Extension cords provided in combination with a storage reel of some kind are known, including some that are attached to a reel to provide for ease of storage or carrying. Some examples, provided in a variety of forms as stand alone devices or integral features of tools, appliances or workshop equipment, enclose the reel within a housing, which may include a crank or a spring or a motor coupled to the reel for retracting the cord into the housing as it is wound on the reel. Other examples include several electrical outlets on the reel or housing to enable additional cords to be plugged into the storage reel device.

However, a disadvantage of these prior art arrangements is that such a storage reel is not available without the extension cord, so that a person having an existing extension cord can obtain the functionality provided by such storage reels without having to purchase the built-in extension cord. Further, while some known reels provide several electrical outlets, they do not provide circuit overload protection for any cords that may be plugged into these electrical outlets. What is needed is a cord storage reel that overcomes these and other deficiencies in the prior art.

### SUMMARY OF THE INVENTION

Accordingly, there is disclosed a storage reel for use with an existing electrical cord, comprising a spool, having a hollow hub, the hub further including a bushing disposed along the axis of the hub for rotatably supporting the hub of the spool on an axle; and an electrical circuit mounted within the hub of the spool and having line and neutral conductors connected to an AC plug mounted in a recessed cavity of the hub to corresponding line and neutral terminals of a plurality of standard AC receptacles mounted in an end of the hub on the side of the spool. The invention thus combines the utility of a multi-tap outlet box and a convenient, portable storage reel in a single unit.

In another aspect, the electrical circuit having three wires, for line, neutral and ground conductors, is provided.

In another aspect, the storage reel includes a circuit breaker mounted on the side of the spool adjacent the AC receptacles.

In another aspect, a frame is provided as a one-piece structure providing a base, a handle for carrying the storage reel, and the axle that supports the hub enabling the hub to rotate freely.

In another aspect, the storage reel includes a crank handle to facilitate winding the user's existing electrical cord on the spool.

In another aspect, the storage reel includes a locking pawl to prevent rotation of the spool and unwinding of the electrical cord during transport or storage.

### BRIEF DESCRIPTION OF THE DRAWINGS

FIG. 1 illustrates a pictorial view of one embodiment of a cord storage reel according to the present invention;

FIG. 2 illustrates a side view of the embodiment of FIG. 1; and

FIG. 3 illustrates a wiring diagram of one embodiment of an electrical circuit as used in the embodiment of FIG. 1.

### DETAILED DESCRIPTION OF THE INVENTION

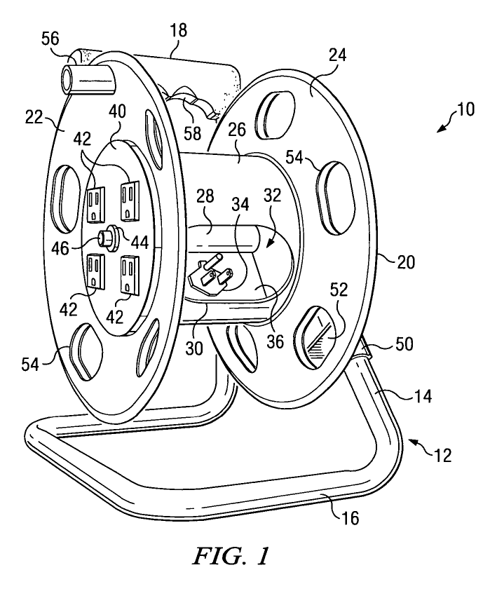

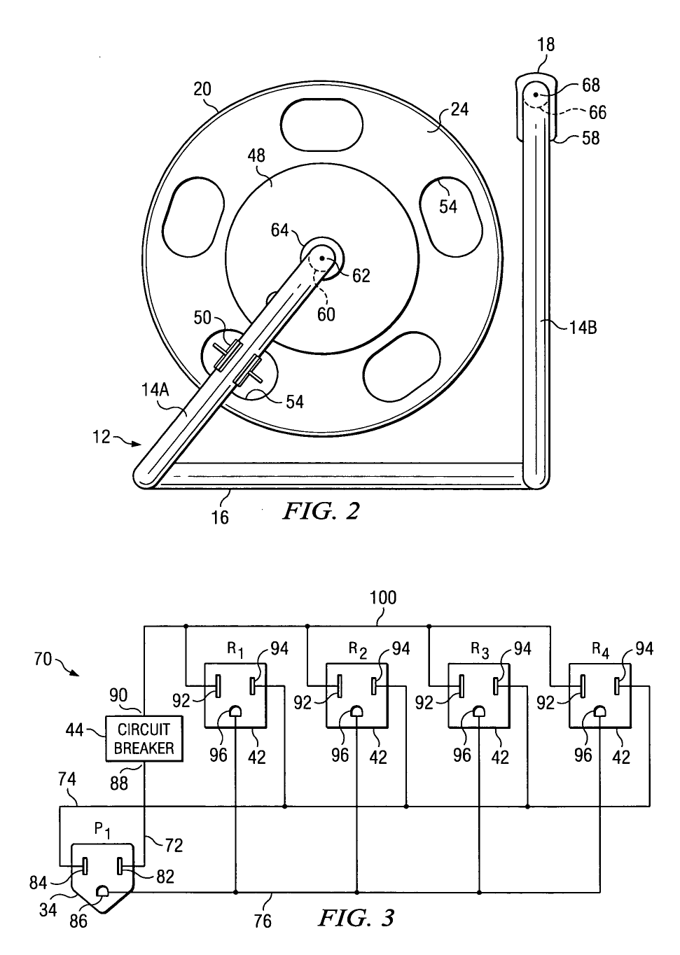

Referring to FIG. 1, there is illustrated a pictorial view of one embodiment of a cord storage reel according to the present invention. The cord storage reel 10 is supported on a frame 12, bent or formed from a single or unitary length of metal tubing or rod stock, such as steel or aluminum, to provide a side portion 14, a base portion 16 and a handle portion 18. The side portion 14 includes an axle (not visible in FIG. 1) that extends perpendicularly from the plane of the side portion 14 to support a spool 20 (See also FIG. 2). The spool 20 rotates on the axle during winding or unwinding of an extension cord (not shown) on or from the cord storage reel 10, as will be further described hereinbelow. The frame 12 may also be fabricated by welding individual lengths of the tubing or rod to form the complete frame 12. In yet other embodiments, the frame 12 may be fabricated of plastic tubing or rod having properties suited to the application. The frame 12 maybe painted or coated or anodized, if aluminum is used as the material. The handle portion 18 may include a hand grip 58 installed over the end (not shown) of the frame 12 forming the handle portion 18.

The cord storage reel 10 includes a spool 20 for storing an electrical extension cord. The spool 20 includes a first side 22, a second side 24, and a hollow cylindrical hub 26. The first and second sides 22, 24 may be generally disc (discoid) shaped, parallel to each other, and attached to or formed integral with the ends of the hollow hub 26. Further, the first and second sides 22, 24 may be slightly convex in profile on the side attached to the hollow hub 26. This profile enables an extension cord to be more easily wound on the spool 20. The spool 20, including the first and second sides 22, 24 and the hollow hub 26, may be stamped of metal or molded of a thermosetting plastic material such as a high temperature flame retardant polypropylene, typically in two pieces as will be recognized by persons skilled in the art.

In the embodiment shown, the diameter of the first and second sides 22, 24 is approximately ten (10) inches and the separation of the first and second sides 22, 24 is approximately 3.5 inches at the hub and approximately 5.0 inches at the outer edge of the first and second sides 22, 24. The diameter of the hub 26 is approximately 5.25 inches. These dimensions, wherein the diameter of the first and second sides 22, 24 is substantially larger than the diameter of the hub, enable the spool 20 to accommodate up to 100 feet of an extension cord having 16/3, 14/3, or 12/2 construction, or up to 75 feet of an extension cord having 12/3 construction. The first number in these designations identifies the gauge of the wire in the extension cord and the second number identifies the number of conductors. Thus, a 16/3 designation identifies a three conductor cord constructed of 16 gauge conductors.

Surrounding the axis of the hollow hub 26, between the first and second sides 22, 24 of the spool 20, is a bushing 28, visible in FIG. 1 through an opening 30 to a recessed cavity 32 in the hollow hub 26. The bushing 28 provides a bearing (See FIG. 2) that permits the spool 20 to rotate freely about the axle that may, for example, extend from the side portion 14 of the frame 12. Also shown within the recessed cavity 32 is an AC plug 34 mounted on a panel 36 such that the prongs of the AC plug 34 extend outward from the axis of the hollow hub 26. The AC plug 34 is part of an electrical circuit (designated with reference number 70 in FIG. 3) enclosed within the hollow hub 26 to be described hereinbelow. An end panel 40 of the first side 22 of the spool 20 is shown, generally disposed in the center portion of the first side 22 of the spool 20. Mounted on the first end panel 40 of the first side 22 are a plurality of AC receptacles 42. Although four such AC receptacles 42 are shown, the number of AC receptacles 42, which may also be called AC outlets 42, may be varied to suit a particular application.

Also located on the end panel 40 of the first side 22 of the spool 20 is a circuit breaker 44. In the illustrative embodiment the circuit breaker 44 is preferably a push-to-reset type. A reset button 46, which maybe disposed within the center of the circuit breaker 44, is also shown in FIG. 1. In other embodiments, the circuit breaker may be a fuse enclosed within a suitable receptacle to enable replacement. In other alternative embodiments, the circuit breaker may be incorporated with an ON/OFF switch. The plurality of AC receptacles 42 and the circuit breaker 44 also form part of the electrical circuit within the hub 26, to be described in FIG. 3.

Continuing with FIG. 1, other features of the cord storage reel 10 of the illustrated embodiment, when supported on a frame 12, are spool lock 50 having a pawl 52 for engaging one of a plurality of openings 54 in the second side 24 of the spool 20. The spool lock 50, which may be molded from a polypropylene material, is provided with a “C” shaped section that acts as a resilient clamp, enabling it to be snapped over the frame 12 proximate (i.e., near) the position of one of the plurality of openings 54 in the second side 24 of the spool 20. The resilient aspect of the spool lock 50 also enables the spool lock 50 to be rotated about the section of the frame 12 that is opposite an opening 54 in the second side 24 of the spool 20. Thus, the pawl 52 of the spool lock 50 can be positioned away from the second side 24, and a nearest opening 54 therein, enabling the spool 20 to rotate freely about an axle (not shown); or the spool lock 50 may be pivoted toward the nearest opening 54 so that the pawl 52 engages the nearest opening 54 in the second side 24 of the spool 20, preventing, the rotation of the spool 20. This feature may be provided to prevent the unwinding of an electrical cord that may be stored on the storage reel 10 when the storage reel 10 is being transported or placed in a stored location.

In the embodiment illustrated, the openings 54 in the first and second sides 22, 24 are disposed along radii of the spool 20, at approximately a constant radius from the axis of the spool 20 and spaced at approximately uniform angles around the respective side of the spool 20. In the example shown, this angle is approximately 72 degrees. In other embodiments, there may be four such openings 54 disposed approximately 90 degrees apart, or six openings disposed at 60 degree angles, and so on. Further, a crank handle 56 may be attached to the first side 22 of the spool 20, in a location where one of the openings 54 has been omitted. Such a crank handle 56 enables the spool 20 to be turned by a user to wind an electrical cord (not shown) onto the spool 20 for storage thereon. The openings 54, which may have a cross-sectional area of between two and three square inches in the example described herein, are generally rounded in shape but may be circular, elliptical, ovoid, rectangular, or any other shape. The purpose of the openings 54 is to permit air to circulate through the coils of the extension cord that is wound on the spool 20 of the cord storage reel 10.

Referring to FIG. 2 there is illustrated a side view of the embodiment of FIG. 1. Many of the structural features of FIG. 2 are the same is shown in FIG. 1 and bear the same reference numbers. The illustrative frame 12 is shown, including the side portion 14. The side portion 14 is defined by two sections 14A and 14B of the entire length of the frame 12. The first section 14A, extending upward from the base portion 16 at an angle of approximately 60 degrees, joins a first end of the axle 60 (shown in cross-section by a phantom line) at an axis 62. The axis 62 is also the axis of the hub 26, its bushing 28 and the axle 60. It will be appreciated that the axle 60, which rotatingly supports the spool 20 along the hub bushing 28, extends into the page of the drawing, away from the viewer, at a right angle to the side portion 14A. The hub bushing 64 is disposed in the center of a second end panel 48 of the second side 24 of the spool 20. In one embodiment of the cord storage reel 10, the axle 60 may extend entirely through the hub 26 of the spool 20 and may be supported therealong by the hub bushing 28. In another embodiment, the axle may extend only part-way through the hub 26 and a shortened bushing 28. Also shown on the first side section 14A, in juxtaposition with one of the plurality of openings 54, is the spool lock 50, that clamps around the first side section 14A.

Continuing with FIG. 2, the second section 14B of the side portion 14 of the frame 12 is shown extending upward from the base portion 16 at an angle of approximately 90 degrees. The second section 14B of the side portion 14 of the frame 12 joins a first end 66 (shown in cross-section by a phantom line) of the handle portion 18 at a second axis 68 of the first end 66.

It will be further appreciated that, in the illustrative embodiment, the axle 60 and the handle portion 18 of the frame 12 are disposed at approximately 90 degree angles (into the page of the figure) with respect to the first and second sections 14A, 14B of the side portion 14 of the frame 12. In another embodiment (not shown), the handle portion 18 may be oriented parallel to the plane of the first and second side sections 14A and 14B and centered over the spool, simply by modifying the frame 12. The handle portion 18 includes the handgrip 58 installed on the handle portion 18. The handgrip 58 may be fabricated of a synthetic foam material to provide a measure of comfort when carrying the cord storage reel 10.

Referring to FIG. 3 there is illustrated a wiring diagram of one embodiment of an electrical circuit as used in the embodiment of FIG. 1. The electrical circuit 70, which is contained within the hub 26 of the spool 20 as described hereinabove, connects an AC plug 34 (P1) to a plurality of AC receptacles 42 (R1, R2, R3 and R4). A line conductor 72 is connected between a line terminal 82 of the AC plug 34 and a first terminal 88 of a circuit breaker 44. A second terminal 90 of the circuit breaker 44 is connected via a line conductor 100 to the line terminals 92 of each of the AC receptacles 42. A neutral conductor 74 is connected between a neutral terminal 84 of the AC plug 34 and each of the neutral terminals 94 of each of the AC receptacles 42. A ground conductor 76 is connected between a ground terminal 86 of the AC plug 34 and each of the ground terminals 96 of the AC receptacles 42.

The circuit breaker 44 shown in FIG. 3 may, in the illustrated embodiment, be rated at ten to twelve Amperes, in a cord storage reel intended for use with standard 120 Volt AC and conventional hand power tools and lighting devices. Persons skilled in the art will further appreciate that the cord storage reel 10 described herein is readily scalable to various current and voltage demands by adjusting the conductor and component ratings, physical sizes of the structural features, and the like. Moreover, in an alternate embodiment (not illustrated), an annunciator or other indicator may be coupled with the circuit breaker to sound or display an alerting signal in the event the circuit breaker trips.

While the invention has been shown in only one of its forms, it is not thus limited but is susceptible to various changes and modifications without departing from the spirit thereof. For example the cord storage reel described herein maybe constructed in different sizes to accommodate different sizes or lengths of extension cords. The frame may be equipped with non-skid feet to prevent sliding along a floor surface. While the cord storage reel described is shown oriented vertically, the design of the frame that is illustrated permits it to be placed on its side, with the spool oriented horizontally. In some embodiments, the frame may be configured to support the spool in a horizontal orientation. Retention devices to secure the plugs of extension cords plugged into the AC receptacles may be provided. Individual circuit breakers for each AC receptacle may be provided. In other embodiments, the openings in the sides of the spool may be deleted. Further, instead of the spool lock described, the spool lock 50 and its pawl 52, the combination may be configured as a brake. In this embodiment, when the spool lock is slid along the frame 12 in a direction toward the rim of the second side portion 24, the “pawl” 52 of the spool lock 50 wedges against the second side 24 of the spool 20, preventing the spool 20 from rotating.

1. A storage reel for an electrical cord, for being rotatably supported on an axle attached to a frame, the storage reel comprising:
a spool having a hollow cylindrical hub of a first diameter, an axial bushing in the hub defining an axis of rotation, and first and second circular, parallel sides of the spool formed integrally with and on opposite ends of the hub, the circular sides having a second diameter larger than the first diameter; and
a circuit connecting a standard electrical plug via at least a line and a neutral conductors to a plurality of standard electrical receptacles connected in parallel across the line and neutral conductors and a circuit breaker is connected in the line conductor and centrally located in the first end of the hub coincident with the first side of the spool, wherein the circuit is enclosed within the hub such that the electrical plug is mounted in a recessed cavity in the hub facing away from the axial bushing of the hub, and the plurality of electrical receptacles are mounted in a first end of the hub coincident with the first side of the spool, disposed around the axial bushing in the hub, and accessible from the first side of the spool.

2. The storage reel of claim 1, wherein the circuit connecting the plug and the receptacles includes a third, ground conductor.

3. (canceled)

4. The storage reel of claim 1, wherein the first side of the spool includes a crank handle disposed a first radial distance from the axis of rotation of the spool and attached to and extending away from the first side of the spool, wherein the crank handle enables the rotation of the spool about the axle.

5. The storage reel of claim 1, wherein the spool is adapted for storing an electrical extension cord wound thereon, a receptacle end of the extension cord having been connected to the plug of the apparatus before winding the extension cord upon the spool.

6. The storage reel of claim 1, wherein the circuit provides a distribution of electric current to each of the plurality of receptacles.

7. A storage reel for an electrical cord, comprising:
a frame having a side portion and an axle extending at a right angle from the side portion;
a spool, having a hollow hub and first and second parallel, discoid sides having a first diameter, each first and second side formed integrally with and disposed respectively on first and second opposite ends of and normal to an axis of the hub, the hub further including a bushing disposed along the axis of the hub for rotatably supporting the hub of the spool on the axle; and
an electrical circuit enclosed in the hub of the spool and having first, second, and third conductors respectively connecting a line, a neutral, and a ground terminal of a standard three-prong AC plug to corresponding line, neutral, and ground terminals of a plurality of standard three-pin AC receptacles, wherein the AC plug is oriented radially outward from the axis of the hub and mounted within a recessed cavity of the hub disposed between the first and second sides of the spool;
circuit breaker connected in series with the line conductor between the line terminal of the AC plug and the line terminals of the plurality of AC receptacles wherein the circuit breaker is centrally mounted in the hub to be accessible for resetting from the first side of the spool; and
a pivoting spool lock mounted on the side portion of the frame is adapted to pivotably engage a proximate one of the radially-disposed openings in the second side of the spool to prevent rotation of the spool on the axle.

8. (canceled)

9. (canceled)

10. The storage reel of claim 7, wherein the hub of the spool comprises:
a hollow cylinder having a second diameter and an axial length defining a spacing between the first and second sides of the spool; wherein
the plurality of AC receptacles are oriented outward from and mounted in the first side of the spool and within a boundary defined by the second diameter of the hub.

11. The storage reel of claim 7, wherein the frame further comprises a base portion extending from a first end of the side portion and substantially parallel to the axle.

12. The storage reel of claim 7, wherein the frame further comprises a handle portion extending from a second, opposite end of the side portion from the base portion and oriented in substantially the same direction as the base portion and the axle.

13. The storage reel of claim 12, wherein the handle portion is substantially parallel with the axle.

14. The storage reel of claim 7, wherein the frame is formed of a unitary length of tubing, bent from a single length of the tubing or a plurality of lengths of the tubing welded together.

15. The storage reel of claim 14, wherein the frame includes a handle portion and a base portion oriented in the same direction as the axle and extending from respective opposite ends of the side portion, such that the base portion and the handle portion are substantially parallel to the axle.

16. The storage reel of claim 7, wherein the spool is formed of a polypropylene material.

17. The storage reel of claim 7, wherein the first and second sides of the spool further include a plurality of radially-disposed openings in each first and second side of the spool, the openings having a substantially rounded shape and positioned in the respective first and second sides of the spool between an outline substantially defined by the diameter of the hub and the first diameter of the first and second sides of the spool.

18. (canceled)

19. The storage reel of claim 7, wherein the spool lock is adapted to rotatably engage a tubular member of the frame such that the spool lock operates as a pawl to engage the proximate opening in the second side of the spool.

20. The storage reel of claim 7, wherein the first side of the spool further comprises a crank handle disposed proximate and within the first diameter of the first side of the spool and at a right angle thereto.

21. The storage reel of claim 7, wherein the electrical circuit provides a distribution of electric current to each of the plurality of AC receptacles.

22. The storage reel of claim 9, wherein the storage reel may be supported with the base portion resting on a surface or the side portion resting on the surface.

23. The storage reel of claim 7, wherein the spool is adapted for storing an electrical extension cord wound thereon, a receptacle end of the extension cord having been installed on the AC plug of the apparatus before winding the extension cord upon the spool.

24. The storage reel of claim 7, wherein the electrical circuit is a two-wire electrical circuit mounted in the hub of the spool and having first and second conductors respectively connecting a line and a neutral terminal of a standard two-prong AC plug to corresponding line and neutral terminals of a plurality of standard two-pin AC receptacles.
